(19) United States
(12) Patent Application Publication
(10) Pub. No.: US 2007/0031591 A1
(43) Pub. Date: Feb. 8, 2007

(54) Method of repairing a metallic surface wetted by a radioactive fluid

(75) Inventors: Warren R. Junker, Monroeville, PA (US); John P. Lareau, Granby, CT (US); Roman Maev, Windsor (CA); Emil Strumban, Oak Park, MI (US)

Correspondence Address: WESTINGHOUSE ELECTRIC COMPANY, LLC, P.O. BOX 355, PITTSBURGH, PA, 15230-0355, US

(73) Assignees: TDM Inc., Windsor (CA); Westinghouse Electric Company LLC, Pittsburgh, PA (US)

(21) Appl. No.: 11/198,482

(22) Filed: Aug. 5, 2005

(51) Int. Cl. B05D 3/00; B05D 7/00; B05D 1/12

(52) U.S. Cl. 427/140; 427/421.1; 427/180

(57) ABSTRACT

The wetted surface of a pressure vessel, a structural internal or a weld is repaired by removing the contacting radioactive fluid, forming a powder mixture of metallic particles and ceramic particles and then spraying the powder mixture on the formerly wetted surface to form a protective cold sprayed coating thereon. As-deposited coatings having a surface smoothness of 125 RMS or better may be nondestructively examined by ultrasonic, eddy current or dye penetrant tests without a preliminary grinding step.

### CROSS REFERENCE TO RELATED APPLICATIONS

This application claims the benefit of U.S. Provisional Patent Application No. 60/599,518, filed Aug. 6, 2004.

### BACKGROUND OF THE INVENTION

The present invention relates to a method of repairing metallic surfaces wetted by radioactive fluids and more particularly to a method of repairing metallic surfaces subjected to radioactive environments that are susceptible to stress corrosion or erosion.

After decades of exposure to high velocity, high temperature, high pressure circulating water and/or steam, the metallic surfaces of the structural components of the primary circuits of water cooled nuclear reactor plants have shown indications of cracking or erosion in routine nondestructive examinations. In some cases, the components were cracked and leaking. Heretofore, the suspect surfaces have been repaired using various known field welding techniques. As employed herein, the term “repair” includes precautionary proactive repairs before the metallic surfaces have actually degraded as well as repairs of corroded or eroded surfaces. Thus, in many situations, weld overlays have been deposited over suspect welds and their heat affected zones and over other suspect surfaces in the primary circuits. In other situations, suspect welds comprising Alloy 82 or Alloy 182 filler metal compositions have been at least partially removed and replaced with welds deposited with a different filler metal composition such as Alloy 52 or Alloy 152. These field welding techniques have been accompanied by significant personnel radiation exposure, costs and lost time on critical path schedules. Undesirably, these welding techniques result in high temperatures stresses as well as chemistry dilutions of the base metal.

### SUMMARY OF THE INVENTION

It is an object of the present invention to provide a method of repairing metallic surfaces previously wetted by radioactive fluids without generating high temperature stresses in the base metal. It is a further object to repair susceptible welds without diluting the chemistry of the base metal.

With these objects in view, the present invention generally resides in a repair method wherein a radioactive fluid is removed from contact with a metallic surface. In preferred practices, the metallic surface may be the inner surface of a pressure vessel or pipe, the surface of an internal structure or the surface of a weld or its heat affected zone.

In the general practice of the present invention, a powder mixture of metallic particles and ceramic particles is formed. In preferred practices, the metallic powder is comprised of irregular shaped, most preferably nickel or a nickel alloy such as Alloy 690 or a stainless steel such as Type 304 or Type 316 stainless steel, particles and the ceramic powder is comprised of spherical shaped, most preferably titanium carbide, particles.

In the general practice of the present invention, the powder mixture is cold sprayed on the metallic surface to form a coating thereon. Thus, the powder is a mixture of metallic particles at temperatures substantially below their melting temperatures that are sprayed by gases flowing at supersonic velocities at the metallic surfaces to be coated. In certain preferred practices, asymmetric, concave and/or convex metallic surfaces may be coated. Preferably, the coatings are at least 300 microns thick.

In other preferred practices of the present invention, the coatings are nondestructively examined by an ultrasonic, eddy current or dye penetrant test. In practices where coatings having surfaces characterized by a smoothness of 125 RMS or better are deposited, the as-deposited coatings can be examined by one of these tests. Advantageously, a preliminary surface grinding step, with the concomitant generation of airborne dust particles, need not be employed.

### BRIEF DESCRIPTION OF THE; DRAWINGS

The invention as set forth in the claims will become more apparent from the following detailed description of a preferred practice thereof as shown, by way of example only, by the accompanying drawings, wherein:

FIG. 1 is a schematic representation of a primary circuit in a nuclear reactor which may be repaired in accordance with the present invention;

FIG. 2 is an enlarged schematic representation of a removable pressure vessel head with a robot controlled cold spray gun positioned under the head before commencing a repair of the head in accordance with a preferred practice of the present invention; and

FIG. 3 is an enlarged schematic representation of the pressure vessel head and the cold spray gun of FIG. 2 while repairing a weld surface and heat affected zones; and

FIG. 4 is a schematic representation of a pressure vessel with a robot controlled cold spray gun positioned within a safe end before commencing a repair of a safe end weld surface in accordance with another preferred practice of the present invention.

### DESCRIPTION OF THE PREFERRED PRACTICES

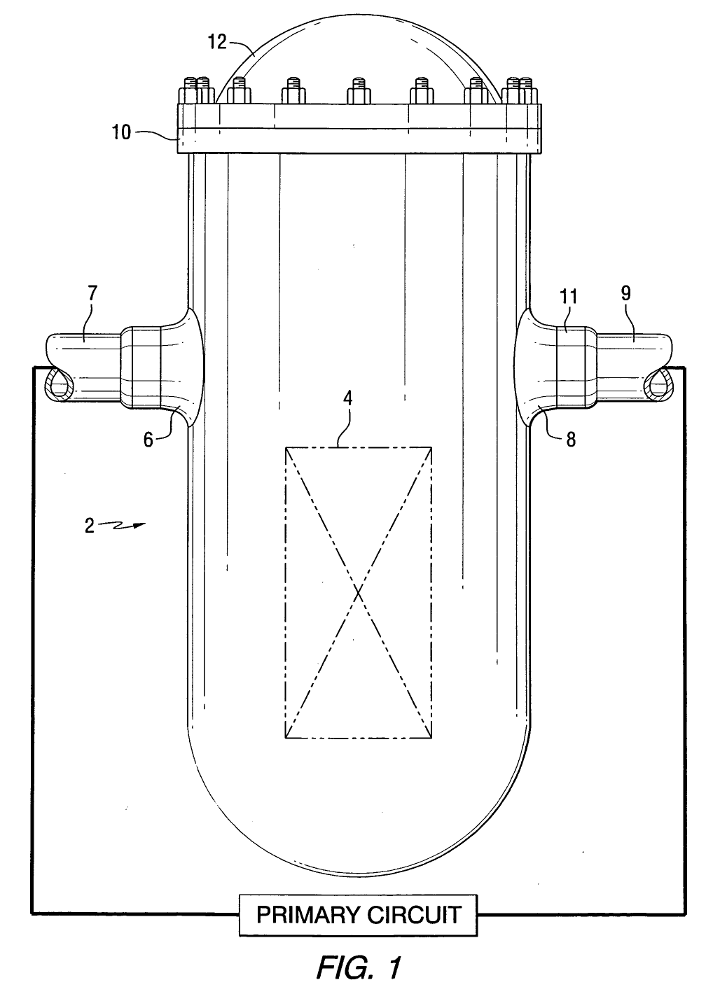

The repair method of the present invention may be advantageously employed to repair the wetted surfaces of the welds and the metallic components of fluid cooled nuclear reactors. Referring now to the drawings and in particular to FIG. 1 there is depicted a typical reactor pressure vessel 2 of a pressurized water nuclear reactor of the type employed to generate commercial electric power. Similar pressure vessels are employed in pressurized water reactors and in other light and heavy water reactors and other types of nuclear plants. Reactor pressure vessels have radioactive materials in their core regions 4 for generating heat that is transferred to a fluid such as water, steam, a liquid metal or a gas recirculating in a closed primary circuit or loop. Thus, reactor pressure vessels 2 of pressurized water nuclear reactors have inlet nozzles 6 and outlet nozzles 8 operatively connected with the cold legs 7 and the hot legs 9, respectively, of the primary circuits for recirculating high temperature, high pressure, high velocity water to steam generators for generating steam that drive remotely located turbines (not shown). As is depicted by FIG. 1, safe ends 11 may be welded between the pressure vessel 2 and the primary circuit. In addition, safe ends may be welded between internal vessel structures fabricated of different materials of construction. The pressure vessel 2 has a flange 10 for seating a removable flanged head 12. Over time, the radioactivity levels of the recirculating fluids tend to build up and the fluids contaminate and/or erode the wetted surfaces of the reactor pressure vessels 2 and the balance of the primary circuits.

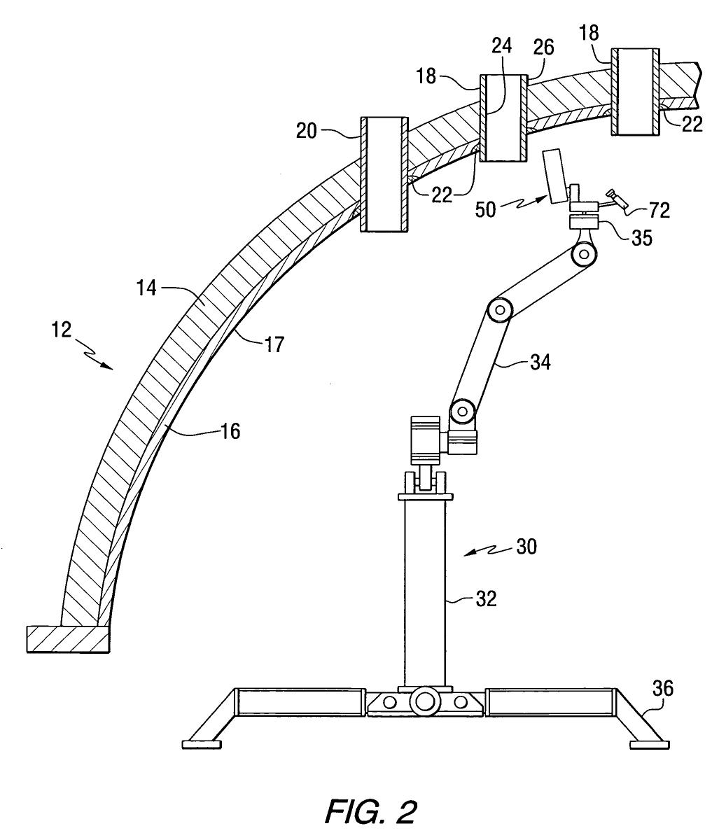

As depicted by FIGS. 2-4, reactor pressure vessels 2 and their heads 12 generally have heavy carbon steel or low alloy shells 14 and relatively thin stainless steel liners 16 with concave inside surfaces 17. The heads 12 have penetrations 18 extending from their interior regions and peripheral penetrations 20 extending from their highly curved regions, which are joined by structural welds 22. These welds also form part of the pressure boundaries of the pressure vessels. The penetrations 18 of reactor pressure vessels are generally tubes or pipes having concave shaped inner surfaces 24 and convex shaped outer surfaces 26 through which in-core instrumentation lines or control rod drive mechanisms travel when the plant is on-line. These penetrations 18 may extend about one to six inches beyond the inside surfaces 17 into the pressure vessels and are generally fabricated of nickel base alloys such as Alloy 600 or Alloy 690. In addition, Alloy 800 materials have been used in some primary circuits. Other penetrations may be fabricated of a stainless steel or other suitable composition, be solid metal or have other cross sectional shapes. The welds 22 are generally comprised of nickel based Alloy 82 (AWS specification ERNiCr-3), Alloy 182 (AWS specification ENiCr-3), Alloy 52 (AWS specification ERNiCrFe-7) or Alloy 152 (AWS specification ENiCrFe-7).

The geometry of the weld joints between the concave inside surfaces 17 of the heads 12 and the generally perpendicular penetrations 18 result in asymmetric welds 22 (known as J-groove welds), i.e., weld joints where the penetrations extend from the heads 12 at angles other than 90°. This joint design inherently generates complex stress patterns in the heads 12 and is susceptible to stress corrosion cracking. The J-groove welds around the peripheral penetrations 20 at the highly curved regions of the heads 12 have proven to be particularly susceptible to stress corrosion cracking because of the higher asymmetric stresses.

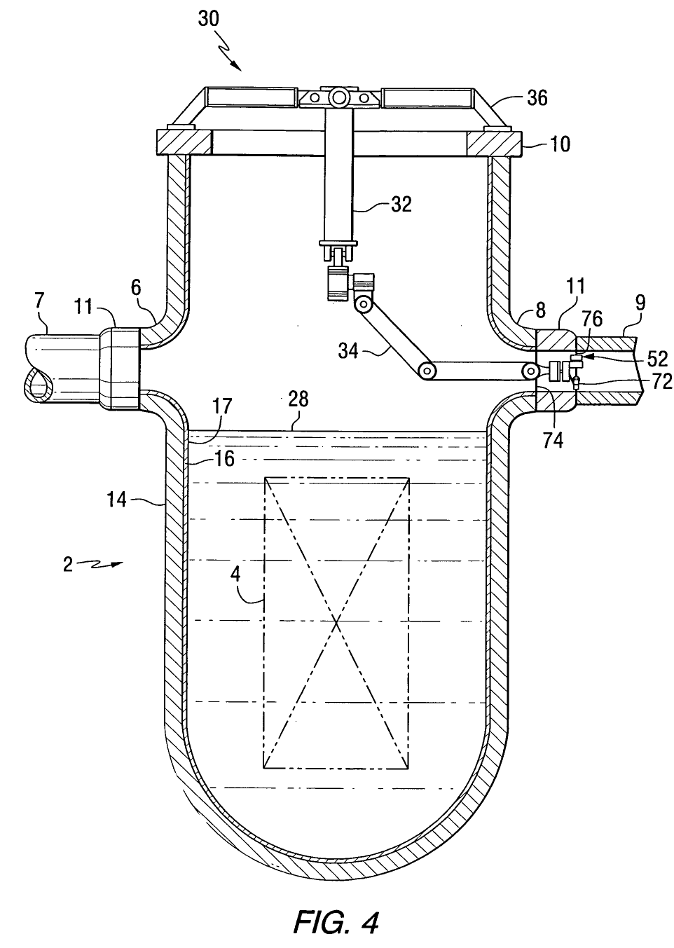

In the general practice of the present invention, the contaminating fluid is removed from contact with the metal surface to be repaired. Thus, the method may be employed to repair the wetted surfaces of pressure vessels such as the reactor pressure vessel 2 depicted by FIG. 1 in the course of refueling or maintenance outages when nuclear reactor plants are off-line. Where a penetration weld surface of a pressure vessel head 12 in a pressurized water reactor is to be inspected or repaired, the water level in the pressure vessel 2 may be lowered to the level of the vessel flange 10 or lower so that the head 12 can be accessed. As depicted in FIG. 2, a head 12 could be suspended by a crane (not shown) over a pressure vessel 2 or supported on a nearby head stand. As is depicted in FIG. 4, the water level 28 has been lowered to a point below the bottom of the nozzles 6 and 8 for inspecting and repairing internal structures of the pressure vessel 2.

At the beginning of an outage (or during a previous outage), the welds and the surfaces of other suspect regions may be nondestructively examined for indications of degradation. Because the heads 12 are radioactive, they are preferably examined remotely. Thus, the surfaces may be examined by probes or other devices (not shown) that are manipulated by robots, such as the robot 30 depicted in FIG. 2. The robot 30 of FIG. 2 has a body 32 with an arm 34 having intermediate joints for providing several degrees of freedom at a tool end 35. The body 32 also has supporting legs 36 that may be supported by the reactor pressure vessel flange 10 or by the head stand. The robot 30 of FIG. 2 generally depicts the type of robots employed in the nuclear power industry during outages to inspect and maintain reactor pressure vessels and their structural internals.

In a preferred practice of the present invention, the surface to be repaired may be cleaned of surface oxides, deposits and/or radioactivity. Thus, as depicted by FIG. 2, the robot 30 may be used to position a cleaning head (not shown) under a head 12 for directing abrasive particles at the surface 17 to loosen and remove surface oxides and deposits. Preferably, the heads 12 are cleaned on the head stands so that the abrasive particles and removed materials may be contained and collected. In a preferred practice, the abrasive particles may be sprayed by the below described cold spray apparatus 50. The particles may be one of the below described powder mixtures, ceramic particles or other suitable medium.

In a preferred practice of the present invention to repair penetration welds, and referring to FIG. 2, a coating 40 having a coating surface 42 is formed by cold spraying a powder mixture on a surface of a weld 22 and the adjacent heat affected zones of the liner 16 and the penetration 18 or the penetration 20. The weld 22 may be comprised of, by weight percent, 40%-80% nickel, 10%-35% chromium, up to 15% iron, up to 15% manganese and up to 5% niobium. In addition, a coating 44 also may be formed on the concave shaped, inner surface 24 of the penetration 18 or penetration 20 in the region adjacent the weld 22.

Cold spraying (also known as kinetic spraying or gas dynamic spraying) is a coating process developed in the late 1980s that essentially sprays a powder at a target surface at supersonic velocities. Importantly, and unlike thermal spraying, the powder and the target metal are at temperatures substantially below their melting points. A principal advantage of cold spraying is that a coating may be applied in such a manner that it does not substantially heat or dilute the base metal.

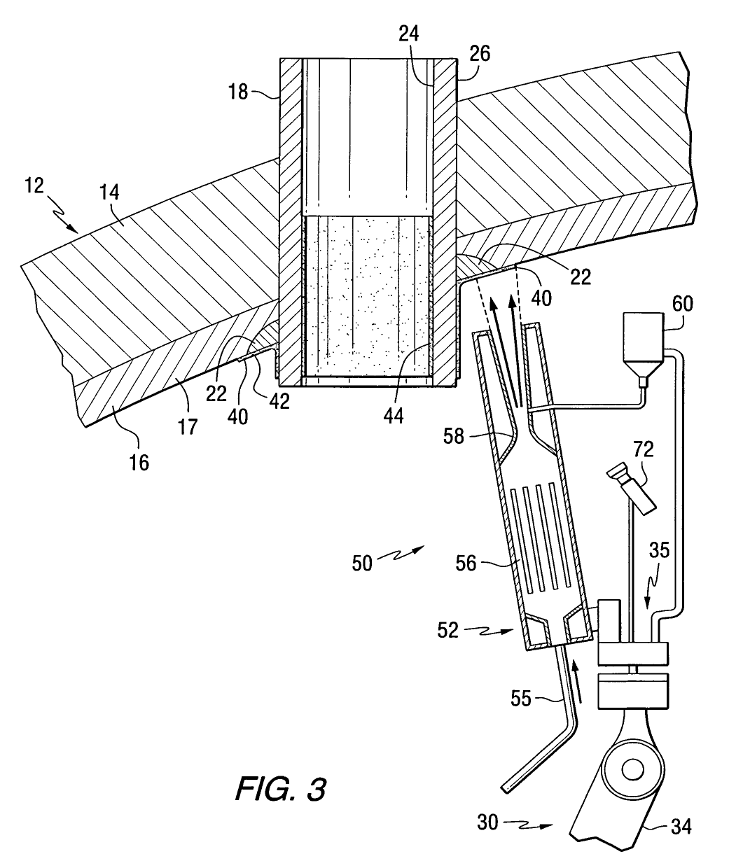

FIG. 3 depicts a cold spraying apparatus 50 wherein a compressed gas from line 55 is introduced into a gun 52 having a heater 56 and a Laval nozzle 58 that accelerates the gas to supersonic velocities. The gas may be air, nitrogen, helium, a mixture of any of these gases or other suitable gas. The gas is heated to increase its supersonic velocity. A powder mixture from a source 60 then may be entrained by the high velocity gas and directed at the weld to build up the coating 40. The gun 52 may be positioned about one half inch to about one inch from the inner surface 17 during the cold spraying step. Preferably, the spray is oriented perpendicularly to the surface 42 of the coating 40 being deposited. FIG. 3 generally depicts the cold spray apparatus of U.S. Pat. No. 6,402,050 by Kashirin et al., which is commercially available in modernized models from TDM, Inc. of Windsor, Canada. This apparatus 50 is relatively small and readily manipulated by a robot 30 (as shown) or manually. Other cold spraying designs are disclosed by U.S. Pat. Nos. 5,302,414; 6,623,796 and 6,722,584. These four patents are hereby incorporated by reference for their disclosures of the structures and operation of cold spraying apparatus. Such cold spray apparatus may employ compressed gases at pressures of from about 100 psi to about 300 psi and may heat the gases to temperatures of up to about 700° C. The gases are heated to increase the sonic velocity. The powder particles may be between 5 and 50 microns or greater.

As is depicted by FIGS. 2 and 3, a video system may be used to monitor the spraying. Thus, the robot 30 may carry a video device such as a TV camera 72. Although the TV camera 72 is depicted as being in close proximity to the cold spray gun 52 for convenient illustration, the camera 72 is preferably positioned further from the gun 52 in actual practice to protect the camera 72 from ricocheting spraying particles. Advantageously, video feedback assures in real time that the proper deposition of metal is taking place.

As the cold spray gun 52 is moved past the inner surface 17 of the head 12, the weld 22 and the outer surface 26 of a penetration 18 or 20, the powder particles begin to bond to the surfaces and accumulate as a layer. The layer can then be built up to the required thickness. The method of the present invention coats incipient cracking or slight imperfections in the surface. The particles bond to the surface 16 adjacent to cracks or imperfections and bond with subsequently sprayed particles. In this way, the cracks or imperfections are bridged by the coating, thus sealing the degraded surface from the environment.

In practices where a coating 44 is to be formed on the concave shaped, inner surface 24 of a penetration 18 or 20 as is shown in FIG. 3, the cold spray gun 52 will need to be modified if it will not fit within the penetration. In these practices, an angled gun nozzle extension (not shown) having a bore with approximately the same diameter as the end of the gun 52 may be attached at the end of the gun 52 to direct the powder spray toward the inner surface 24. In addition, an angled gun extension may be employed to form a coating 40 on the convex shaped, outer surface 26 of a penetration 20 in the region between the peripheral penetration 20 and the highly curved region of the head 12.

In another practice, the present invention may be employed to repair remote surfaces such as the weld surfaces of safe ends during maintenance outages. Thus, as is depicted by FIG. 4, the robot 30 may be supported by the upper flange 10 for operating various inspection and maintenance devices. The robot 30 may be employed to position the cold spray gun 52 in a nozzle 8 or safe end 11 to cold spray a coating on the degraded surface of the nozzle 8, the safe end 11, its weld 74 and/or weld 76.

In preferred practices, the coating 40 is at least 300 microns (0.012 inch) thick. It should be noted that the thickness of the coatings 40 and 44 of FIG. 3 are shown out of proportion for purposes of illustration. Advantageously, cold sprayed coatings 40 will be dense and may have compatible chemistries with the components, sufficient ductility and sufficient bond strength to continue to adhere to the weld in later on-line service.

In certain preferred practices, a coating 40 or 44 may be nondestructively examined by an ultrasonic, eddy current or dye penetrant test. Preferably, the as-sprayed coating 40 can be inspected without a preliminary grinding step when the as-sprayed surface 42 has a smoothness of 125 RMS (root mean square) or better. Advantageously, the coating 40 or 44 may be deposited and examined in less time and at a lower cost than has been required by the prior art repairs of such welds 22.

In the practice of the present invention, the powder mixture is formed of metallic particles and ceramic particles. The metallic particles are preferably comprised of nickel or a nickel alloy (such as Alloy 600, Alloy 690 and Alloy 800), a stainless steel composition (such as Type 304 or Type 316) or a mixture thereof. In addition, they may also be also comprised of iron, titanium, zinc or zirconium. The ceramic particles are preferably comprised of titanium carbide. In addition, they may also be comprised of another metal carbide, oxide or nitride. US Patent Application Publication No. 2003-0219542 discloses several constituents than may be employed in various mixtures of powders. The particles preferably do not contain significant aluminum levels because aluminum interferes with the reactor's nucleonics. Preferably, the metallic particles comprise from 15%-75%, and more preferably 60%-70%, by weight, and the ceramic particles comprise from about 25%-85%, and more preferably 30%-40%, by weight, of the total powder. The particles may have an irregular shape (such as a flake or coral configuration) or a spherical shape. Also, the particles may be comprised of two or more subparticles. In preferred practices, the metallic particles have an irregular shape and the ceramic particles have a spherical shape.

While present preferred practices of the present invention has been shown and described, it is to be understood that the invention may be otherwise variously embodied within the scope of the following claims of invention.

1. A method of repairing a metallic surface weed by a radioactive fluid and susceptible to stress corrosion crack in a nuclear reactor, comprising the steps of:
removing the radioactive fluid from contact with the stress corrosion susceptible metallic surface;
forming a powder mixture of metallic particles and ceramic particles;
cold spraying the powder mixture on the stress corrosion susceptible metallic surface previously wetted by a radioactive fluid to for a coating thereon.

2. The repair method of claim 1, wherein the step of removing the radioactive fluid from the metallic surface comprises:
removing steam or water from the metallic surface.

3. The repair method of claim 1, wherein the step of forming a powder mixture comprises:
forming a powder mixture comprising metallic particles selected from the group consisting of nickel, nickel base alloys, stainless steel and mixtures hereof.

4. The repair method of claim 1, wherein the step of forming a powder mixture comprises:
forming a powder mix comprising metallic particles having an irregular shape.

5. The repair method of claim 1, wherein the step of forming a powder mixture comprises:
forming a powder mixture comprising ceramic particles selected from the group consisting of metal carbides, oxides, and nitrides.

6. The repair method of claim 1, wherein the step of forming a powder mixture comprises:
forming a powder mixture comprising ceramic particles having a spherical shape.

7. The weld repair method of claim 1, wherein the step of forming a powder mixture comprises:
forming a power mixture comprising irregular shaped metal particles comprising nickel and spherical shaped ceramic particles comprising titanium carbide.

8. The repair method of claim 7, wherein the step of forming a powder mixture comprises:
forming a powder mixture, comprising 15%-75%, by weight, irregular shaped metallic particles and 25%-85%, by weight, spherical shaped ceramic powders.

9. The repair method of claim 8, wherein the step of forming a powder mixture comprises:
forming a powder mixture comprising 60%-70%, by weight irregular shaped metallic particles and 30%-40%, by weight, spherical shaped ceramic particles.

10. The repair method of claim 1, wherein the step of forming a powder mixture comprises:
forming a power mixture comprising irregular shaped metallic particles comprising stainless steel and spherical shaped ceramic particles comprising titanium carbide.

11. The repair method of claim 10, wherein the step of forming a powder mixture comprises:
forming a powder mixture comprising 15%-75%, by weight, irregular shaped metallic particles and 25%-85%, by weight, spherical shaped ceramic powders.

12. The repair method of claim 11, wherein the step of forming a powder mixture comprises:
forming a powder mixture comprising 60%-70%, weight irregular shaped metallic particles and 30%-40%, by weight spherical shaped ceramic particles.

13. The repair method of claim 1, wherein the step of cold spraying the powder mixture comprises:
cold spraying the powder mixture on a surface of a weld or its heat affected zone.

14. The method of claim 13, wherein the step of cold spraying the powder mixture comprises:
cold spraying the powder mixture on a weld, the weld comprising, by weight percent, 40%-80% nickel, 10%-35% chromium, up to 15% iron, np to 15% manganese and up to 5% niobium.

15. The repair method of claim 13 wherein the step of cold spraying the powder mixture comprises:
cold spraying the powder mix on a surface of an asymmetric weld.

16. The repair method of claim 1, wherein the step of cold spraying the powder mixture comprises:
cold spraying the powder mixture on a concave surface.

17. The repair method of claim 1, wherein the step of cold spraying the powder mixture comprises:
cold spraying the powder mixture on a convex sure.

18. The repair method of claim 1, wherein the step of cold spraying the powder mixture comprises:
cold spraying the powder mixture on a surface of a weld between a pressure vessel head and a penetration extending from the pressure vessel head.

19. The repair method of claim 1, wherein the metallic surface is the inner surface of a penetration and the step of cold spraying the mixture comprises:
cold spraying the powder mixture from a cold spray gun spaced from the penetration.

20. The repair method of claim 1, wherein the step of cold spraying the powder mixture comprises:
cold spraying the powder mixture on a reactor pressure vessel safe end weld.

21. The repair method of claim 1, including the further step of:
monitoring the coating while cold spraying the powder mixture.

22. The repair method of claim 1, wherein the metallic surface is the surface of a weld and including the further step of:
nondestructively examining the weld surface by an ultrasonic, eddy current or dye penetrant test.

23. The repair method of claim 22, wherein die step of cold spraying the powder mixture comprises:
forming a coating having an as-deposited surface with a smoothness of 125 RMS or better, and
the step of nondestructively examining the weld surface comprises:
nondestructively examining the as-deposited coating.

24. The repair method of claim 1, including the further step of:
abrading the metallic surface before forming the cold sprayed coating thereon.
